(19) United States
(12) Patent Application Publication
(10) Pub. No.: US 2021/0336496 A1
(43) Pub. Date: Oct. 28, 2021

(54) MOTOR ROTOR

(71) Applicants: ZF Automotive UK Limited, Solihull (GB); ZF Automotive Technologies (Shanghai) Co., Ltd., Shanghai (CN); ZF Asia Pacific Group Co., Ltd, Shanghai (CN)

(72) Inventors: Joe Partlett, Shanghai (CN); Mike Davies, Newport (GB); Liu Jideng, Shang Hai City (CN); Thomas Tonks, Solihull (GB)

(21) Appl. No.: 17/238,590

(22) Filed: Apr. 23, 2021

(30) Foreign Application Priority Data
Apr. 24, 2020 (CN) 202010331545.6

(51) Int. Cl. H02K 1/27

(52) U.S. Cl. CPC H02K 1/2766

(57) ABSTRACT

A rotor for an electric motor includes a plurality of laminated sheets assembled into a puck. The puck defines a plurality of apertures for the receipt of rotor magnets. The apertures extend in a substantially circumferential direction around the puck. Each laminated sheet includes a plurality of protrusions and a plurality of corresponding recesses configured to receive the protrusions of an adjacent laminated sheet. The protrusions and recesses are configured to engage with an interference fit. The protrusions and corresponding recesses are positioned at a greater radial distance from a centre of the puck than the apertures and each protrusion is elongate in a substantially circumferential direction of the puck.

### RELATED APPLICATIONS

The present invention claims priority from 202010331545.6, filed 24 Apr. 2020, the entirety of which is incorporated herein by reference.

### TECHNICAL FIELD

The present invention relates to a motor rotor, more particularly but not necessarily exclusively to the motor rotor of an electric motor for use in an electric power-assisted steering system. The invention also relates to an electric motor including such a motor rotor.

### BACKGROUND

Rotors for electric motors are often formed of multiple laminated sheets assembled into a puck, these sheets being shaped so as to form a housing for a plurality of magnets within the rotor. It has been found that, during assembly of the rotor, when the rotor shaft is inserted into the puck, that the laminated sheets can be distorted, causing slight gaps to be formed between the sheets. When operated at high load, these gaps can allow the laminations to move, resulting in an audible clicking noise to be emitted from the rotor. It is desirable to prevent or limit such occurrences.

According to a first aspect, there is provided a rotor for an electric motor, the rotor comprising:
a plurality of laminated sheets assembled into a puck, the puck defining a plurality of apertures for the receipt of rotor magnets, the apertures extending in a substantially circumferential direction around the puck;
wherein each laminated sheet includes a plurality of protrusions and a plurality of corresponding recesses configured to receive the protrusions of an adjacent laminated sheet, the protrusions and recess being configured to engage with an interference fit;
wherein the protrusions and corresponding recesses are positioned at a greater radial distance from a centre of the puck than the apertures and wherein each protrusion is elongate in a substantially circumferential direction of the puck.

The protrusions and recesses form multiple inter-engaging features that effectively lock the laminated sheets together when they are assembled into a puck. By holding the laminated sheets together, the protrusions and recesses prevent or limit delamination that can otherwise occur as the puck is mated with a rotor shaft. They also assist with holding the laminated sheets together when under load during use.

It has been noted by the applicant that the provision of an elongate protrusion provides the desired securing of the laminated sheet without introducing a substantial disturbance to the material properties of the rotor. Such disturbances have been known to occur with interlocking features found on the periphery of the rotor laminations. However, the shape described reduces any effect on the magnet properties of each laminated sheet, limiting any such negative effects.

By “each protrusion is elongate in a substantially circumferential direction of the puck”, it is meant that the elongation is around a periphery of the puck. As will be apparent, this term will include elongations that are curved with the curvature of the circumference of the puck as well as elongations that are in themselves straight but where each elongation is substantially aligned with an outer perimeter of the puck at the position of the elongation.

Each aperture may be elongate in the substantially circumferential direction of the puck, each protrusion being substantially parallel with a corresponding aperture.

The protrusions and apertures may therefore each be straight and parallel or may be curved and parallel, for example such that they are aligned with the outer perimeter of the puck.

Each aperture may be centred with respect to a corresponding aperture.

Each protrusion may be pill-shaped.

### SUMMARY

It has been shown that a pill-shaped protrusion provides a good level of interlocking between the laminated sheets whilst minimising the impact of the material and/or magnetic properties of the laminated sheets and the puck overall.

By “pill-shaped”, it is meant that the protrusion is elongate with linear or curvilinear side portions and semi-circular or substantially semi-circular end portions.

Each protrusion may be the same shape or substantially the same shape as its corresponding recess.

The number of protrusions and corresponding recesses and the number of apertures may be equal.

The length of each protrusion may be at least twice the width of the protrusion, or may be at least three times the width of the protrusion, or may be at least four time the width of the protrusion.

The laminated sheets may further comprise a plurality of inter-engaging features at a lesser radial distance from the centre of the puck than the apertures.

Inter-engaging features within the radial position of the magnets of the rotor can provide additional resistance to delamination of the laminated sheets. Furthermore, it has been found that such inter-engaging features have less impact on the magnetic properties of the rotor. However, due to their position, they also are less effective than the protrusions and recesses found at the periphery at preventing delamination when provided alone.

The inter-engaging features may each include an additional protrusion and a corresponding additional recess configured to receive the additional protrusion of an adjacent laminated sheet. Each additional protrusion and additional recess may engage with an interference fit.

Each laminated sheet may be substantially circular.

Each laminated sheet may include a radial bulge adjacent to each aperture.

Each radial bulge may house the protrusion and recess.

Each laminated sheet may include a central aperture for the receipt of a rotor shaft.

According to a second aspect, there is provided an electric motor comprising a stator and a rotor according to the first aspect.

### BRIEF DESCRIPTION OF THE DRAWINGS

An embodiment of the present invention will now be described in detail with reference to the accompanying drawings, in which:

FIG. 1 shows a perspective view of a rotor according to the first aspect;

FIG. 2 is a plan view of a laminated sheet making up the rotor of FIG. 1;

FIG. 3 is a perspective view of a protrusion and aperture making up the laminated sheet of FIG. 2;

FIG. 4 is a side cross-sectional view of the protrusion shown in FIG. 3, including a corresponding recess; and

FIG. 5 shows an electric motor according to the second aspect of the invention, including a rotor according to the first aspect.

### DETAILED DESCRIPTION

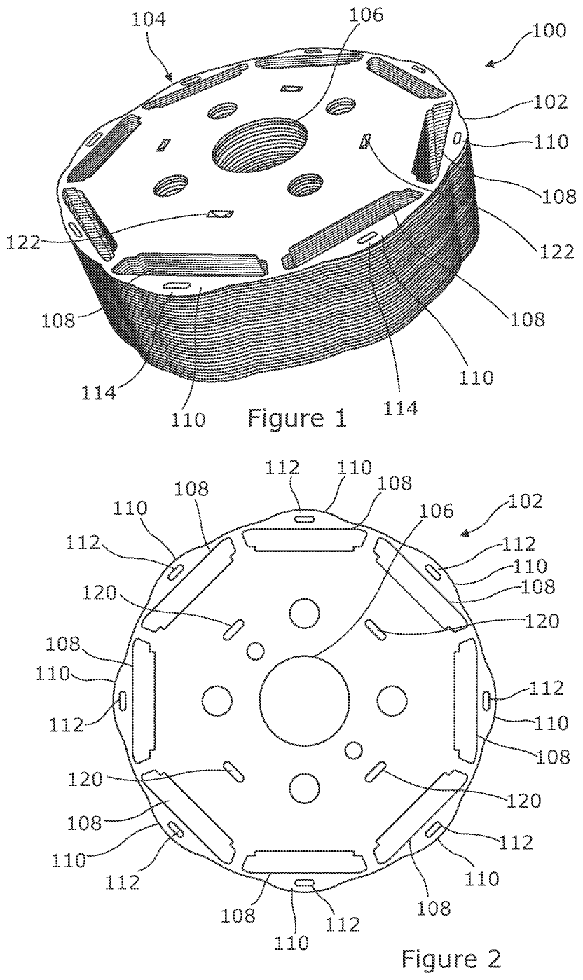

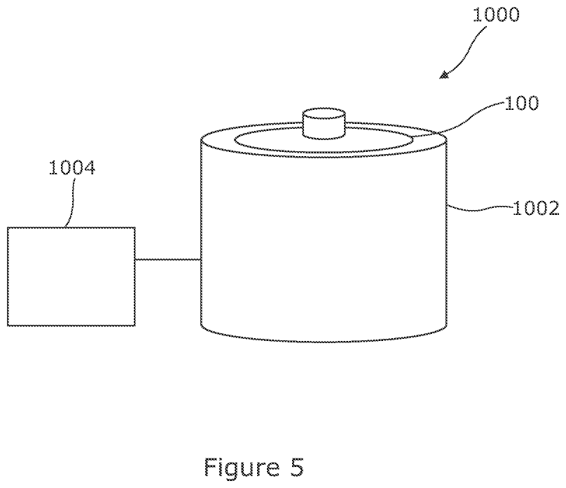

Referring firstly to FIG. 1, there is shown a rotor 100 for an electric motor. The rotor 100 comprises a plurality of laminated sheets 102, which together form a puck 104. The puck 104, from the shape of the laminated sheets 102, provides a central aperture 106 for the receipt of a rotor shaft (not shown), and a plurality of peripheral apertures 108 arranged towards the outer perimeter of the puck 104. The peripheral apertures 108 are provided so as to form a housing for magnets (not shown) that are then utilised to provide propulsive force to the rotor 100 when the rotor 100 forms a part of the motor 1000 shown in FIG. 5.

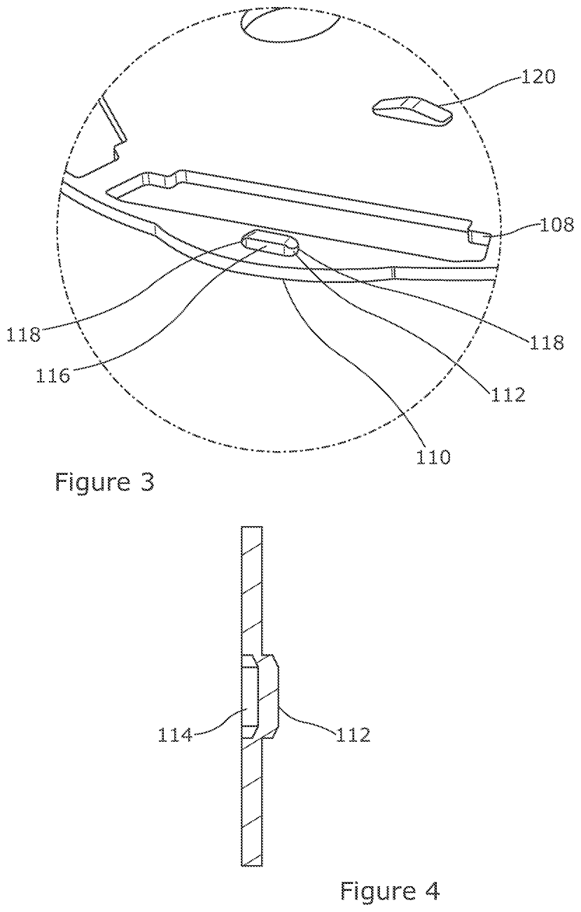

FIG. 2 shows a plan view of a single laminated sheet 102, highlighting the different structures and shapes present on each laminated sheet 102. A total of eight peripheral apertures 108 are formed, equidistantly spaced around the periphery of the laminated sheet 102, and thus the puck 104. The laminated sheet 102 is substantially circular, but includes radially-extending bulges 110 aligned with each peripheral aperture 108. The radial bulges act to direct the magnetic flux of the motor in order that it performs as desired. A perspective view of one of these radially-extending bulges 110, along with the corresponding peripheral aperture 108, is shown in FIG. 3.

Between each peripheral aperture 108 and the outer extent of the corresponding radial bulge 110, a protrusion 112 is formed, at a greater radial distance from the centre of the laminated sheet than the peripheral apertures 108. Each protrusion 112 is shaped and sized so as to form an interference fit with a corresponding recess 114 formed in an adjacent laminated sheet 102. Each laminated sheet 102 is therefore formed with aligned protrusions 112 and recesses 114, and one example is shown in cross-sectional view in FIG. 4.

Each protrusion 112 is elongate in a substantially circumferential direction of the puck. This elongation is also, in the depicted embodiment, parallel to the elongation of the peripheral apertures 108 formed to house the rotor magnets. The elongation is formed such that the length of the protrusion 112 is approximately three times the width of the protrusion 112, although different ratios of the length and width of the protrusion 112 may also be provided without detracting from the technical effect of the elongate protrusion 112. It is desirable that the protrusions are as small as possible, whilst still providing a sufficient contact area to hold the laminated sheets 102 in place.

More specifically, each protrusion 112 is pill-shaped and includes two parallel sides 116 that are parallel to the elongation direction of the protrusion 112, and two semi-circular end portions 118. The corresponding recess 114 associated with each protrusion 112 is similarly-shaped to the protrusion 112, such that the interference fit mentioned above is produced.

By providing the protrusion 112 with an elongate extent, and optionally with the shape specified in the preceding paragraph, the effect on the magnetic properties of the rotor 100 once assembled is limited to an extent whereby the properties of the rotor 100 are not substantially negatively affected by the presence of the protrusions 112 and recesses 114.

The recesses and protrusions are shaped in order to maximise the contact area between the recesses and protrusions when the rotor is assembled. Moreover, this should be accomplished with the minimum size possible in order to limit the effects on the other properties of the rotor. The pill-shape, with an elongate body and semi-circular ends, the recess having a planar base and perpendicular sides, has been found to be the best compromise between effectiveness and size. However, other shapes are possible and will be apparent to the skilled person in the context of the present disclosure.

As is shown in FIG. 4, the protrusion 112 and recess 114 are formed such that they are aligned. This gives the benefit that identical laminated sheets 102 can be stacked on top of one another, but also provides a manufacturing advantage to the manufacturer in that the protrusion 112 and recess 114 can be formed in a single stamping step.

The effect of the inter-engaging of the protrusions 112 and recesses 114 around the periphery of the laminated sheets 102 and thus the puck 104 is that delamination of the puck 104, either during assembly, such as when mounting the puck 104 on a rotor shaft, or during the application of high loads to the rotor 100, is limited or prevented. As mentioned above, the shape of the protrusions 112 allows this limitation of delamination without substantially negatively affecting the operating properties of the rotor 100, and more specifically the magnetic properties of the puck 104.

In order to supplement the protection against delamination provided by the inter-engaging of the protrusions 112 and recesses 114 at the periphery of the puck 104, a further four inter-engaging features are provided at a lesser radial distance from the centre of each laminated sheet. These inter-engaging features are each formed by an additional protrusion 120, visible in FIG. 3, and a corresponding additional recess 122 that receives the protrusion 120, visible in FIG. 1.

As with the first described protrusions 112 and recesses 114, the additional protrusions 120 and recesses 122 engage with an interference fit, such that they may be brought into secure engagement by a simple assembly of the puck 104. Due to their position closer to the centre of the puck 104 than the protrusions 112 and recesses 114, the additional protrusions 120 and recesses 122 do not have the same magnitude of effect on the magnetic properties of the puck 104. As such, the size and shape of the additional protrusions 120 and recesses 122 is less important to the operation of the rotor 100. However, in the present case the additional protrusions 120 and recesses 122 are slightly greater in size but have a similar shape to the outer protrusions 112 and recesses 114.

As touched upon earlier, FIG. 5 shows a motor 1000 including a rotor 100 of the form shown in FIG. 1. The rotor 100 is surrounded by a stator 1002. The motor 1000 is operated by control circuitry 1004 provided that is in communication with, and provides electrical current to, the stator, causing the rotor to rotate due to its magnetic properties.

What is claimed is:

1. A rotor for an electric motor, the rotor comprising:
a plurality of laminated sheets assembled into a puck, the puck defining a plurality of apertures for the receipt of rotor magnets, the apertures extending in a substantially circumferential direction around the puck;
wherein each laminated sheet includes a plurality of protrusions and a plurality of corresponding recesses configured to receive the protrusions of an adjacent laminated sheet, the protrusions and recess being configured to engage with an interference fit;
wherein the protrusions and corresponding recesses are positioned at a greater radial distance from a centre of the puck than the apertures and wherein each protrusion is elongate in a substantially circumferential direction of the puck.

2. A rotor according to claim 1, wherein each aperture is elongate in the substantially circumferential direction of the puck, each protrusion being substantially parallel with a corresponding aperture.

3. A rotor according to claim 1, wherein each aperture is centred with respect to a corresponding aperture.

4. A rotor according to claim 1, wherein each protrusion is pill-shaped.

5. A rotor according to claim 1, wherein each protrusion is the same shape or substantially the same shape as its corresponding recess.

6. A rotor according to claim 1, wherein the number of protrusions and corresponding recesses and the number of apertures is equal.

7. A rotor according to claim 1, wherein the length of each protrusion is at least twice the width of the protrusion, or at least three times the width of the protrusion, or at least four times the width of the protrusion.

8. A rotor according claim 1, wherein the laminated sheets further comprise a plurality of inter-engaging features at a lesser radial distance from the centre of the puck than the apertures.

9. A rotor according to claim 8, wherein the inter-engaging features each include an additional protrusion and a corresponding additional recess configured to receive the additional protrusion of an adjacent laminated sheet, optionally wherein each additional protrusion and additional recess engage with an interference fit.

10. A rotor according to claim 1, wherein each laminated sheet is substantially circular.

11. A rotor according to claim 1, wherein each laminated sheet includes a radial bulge adjacent to each aperture.

12. A rotor according to claim 11, wherein the radial bulge houses the protrusion and recess.

13. A rotor according to claim 1 wherein each laminated sheet includes a central aperture for the receipt of a rotor shaft.

14. An electric motor comprising a stator and a rotor according to claim 1.
